(19) United States
(12) Patent Application Publication
(10) Pub. No.: US 2018/0370441 A1
(43) Pub. Date: Dec. 27, 2018

(54) LIGHTING SYSTEM

(71) Applicant: Gentex Corporation, Zeeland, MI (US)

(72) Inventor: Michael F. Lisowski, Holland, MI (US)

(21) Appl. No.: 16/013,259

(22) Filed: Jun. 20, 2018

Related U.S. Application Data
(60) Provisional application No. 62/523,062, filed on Jun. 21, 2017.

(51) Int. Cl. B60R 1/12; B60R 1/04; B60R 1/08; F21V 13/04; F21V 5/00; F21V 7/00

(52) U.S. Cl. CPC B60R 1/1207; B60R 1/04; B60R 1/088; F21Y 2115/10; F21V 5/002; F21V 7/0083; F21V 13/04

(57) ABSTRACT

A light system is provided for use in a rearview mirror assembly. A printed circuit board (PCB) includes a first side and a second side. A light source is configured to direct light in a first direction parallel with a planar extent of the PCB. A first optical element is coupled to the first side. A collection optic is configured to direct light received from the light source. A reflector optic is in optical communication with the collection optic and is configured to reflect light received from the collection optic. A plurality of light steering areas are configured to steer light propagating in the first optical element. A second optical element is coupled to the second side and is in optical communication with the first optical element. The second optical element is configured to diffuse light received from the first optical element to illuminate an indicia.

### CROSS-REFERENCE TO RELATED APPLICATION

This application claims priority to and the benefit under 35 U.S.C. § 119(e) of U.S. Provisional Application No. 62/523,062, filed on Jun. 21, 2017, entitled “LIGHTING SYSTEM,” the disclosure of which is hereby incorporated herein by reference in its entirety.

### TECHNOLOGICAL FIELD

The present invention generally relates to a light system, and more particularly, to a light system having a light optic configured for use in a rearview mirror assembly.

### SUMMARY OF THE DISCLOSURE

In one aspect of the present disclosure, a light system is provided for use in a rearview mirror assembly. A printed circuit board includes a first side and a second side. A light source is located on the first side and is configured to direct light in a first direction parallel with a planar extent of the printed circuit board. A first optical element is coupled to the first side and includes a collection optic configured to direct light received from the light source. The first optical element includes a plurality of light steering areas are configured to steer light propagating in the first optical element. Light steered from each of the plurality of light steering areas exits the first optical element via an output surface configured to direct light in a second direction that is generally 10-60 degrees relative to a planar extent of the output surface. A second optical element is coupled to the second side and is in optical communication with the first optical element. The second optical element is configured to diffuse light received from the first optical element to illuminate an indicia.

In another aspect of the present disclosure, a light system is provided for use in a rearview mirror assembly that includes a printed circuit board. A light source is proximate the printed circuit board directing light in a first direction. A first optical element is operably coupled to the printed circuit board and includes a collection optic that directs light received from the light source and an output surface that includes a light spreading optic. The first optical element also includes a plurality of light steering areas steer light propagating in the first optical element. Light steered from each of the plurality of light steering areas exits the first optical element via the output surface configured to direct light in a second direction different from the first direction. A second optical element is in optical communication with the first optical element. The second optical element is configured to diffuse light received from the first optical element to illuminate an indicia having a planar extent that is generally perpendicular to the light emitted by the light source.

In yet another aspect of the present disclosure, a light system is provided for use in a rearview mirror assembly that includes a printed circuit board. A light source is proximate the printed circuit board and directs light in a first direction. A first optical element is operably coupled to the printed circuit board and includes a collection optic that directs light received from the light source and an output surface including a light spreading optic. The first optical element also includes a plurality of light steering areas steer light propagating in the first optical element. Light steered from each of the plurality of light steering areas exits the first optical element via the output surface. The plurality of light steering areas increase in size as a distance from the light source increases. A second optical element is in optical communication with the first optical element. The second optical element includes indicia that is illuminated by the light source.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a diagram of a light system of the present disclosure;

FIG. 2 is a front perspective view of the light system of FIG. 1;

FIG. 3 is a diagrammatic view of a light system of the present disclosure disposed in a rearview mirror assembly having an electro-optic element;

FIG. 4 is a diagrammatic view of a light system of the present disclosure disposed in a rearview mirror assembly having a non electro-optic mirror element;

FIG. 5 is a front perspective view of a light system of the present disclosure;

FIG. 6 is a top elevational view of the light system of FIG. 5;

FIG. 7 is a partial exploded bottom perspective view of the light system of FIG. 5;

FIG. 8 is a cross-sectional view of the light system of FIG. 5 taken along lines VIII-VIII; and

FIG. 9 is a bottom perspective view of another light system of the present disclosure.

### DETAILED DESCRIPTION

The present illustrated embodiments reside primarily in combinations of method steps and apparatus components of the light system. The apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

For purposes of description herein, the terms “upper,” “lower,” “right,” “left,” “rear,” “front,” “vertical,” “horizontal,” and derivatives thereof shall relate to the invention as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

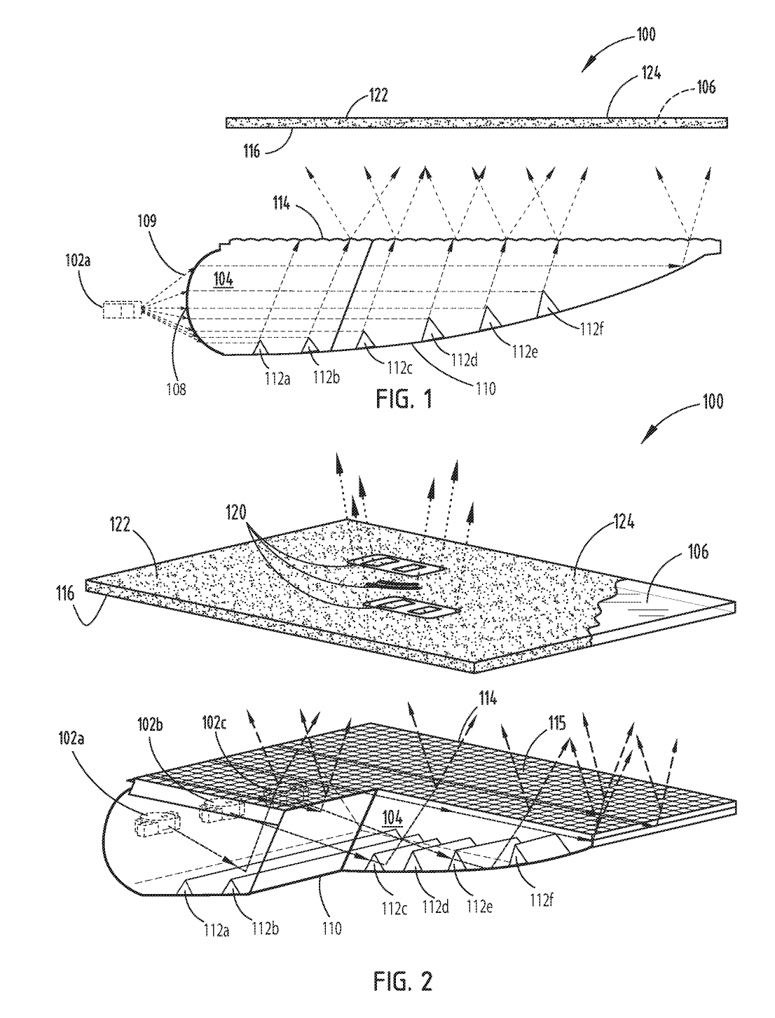

In reference to FIGS. 1 and 2, a light system is shown at reference identifier 100. The light system 100 may include a light source, shown as light emitting diodes (LEDs) 102a, 102b, and 102c. However, the light source may also include other constructions including incandescent lamps, halogen lamps, metal halide lamps, neon lamps, etc. Also, the light source may be a singular light emitting source or a plurality of light emitting sources. The light system 100 also includes a first optical element 104, and an optional second optical element 106. The first optical element 104 may be molded from a light propagating material and may include a collection optic 108, a reflector optic 110, and one or more light steering areas, shown as light steering areas 112a, 112b, 112c, 112d, 112e, and 112f (collectively 112a-112f). The second optical element 106 may be molded from a light diffusing material and may be provided separate from the first optical element 104. Alternatively, the first optical element 104 and the second optical element 106 may be combined to form a single integrated optic.

In the illustrated embodiment, the collection optic 108 is configured to direct light received from LEDs 102a, 102b, and 102c. The collection optic 108 is positioned on one end of the first optical element 104. The collection optic 108 may be elongate and have a cylindrical or other anamorphic configuration. As illustrated, the collection optic 108 is elongate and convex. However, the collection optic 108 could include a partial cylindrical construction, or include a hexagonal or octagonal construction. The collection optic 108 is adjacent to or abutting the light source, which includes the LEDs 102a, 102b, and 102c. In addition, the collection optic 108 is generally configured to disperse light received from the LEDs 102a, 102b, and 102c such that each of light steering areas 112a-112f receive light emitted from the LEDs 102a, 102b, and 102c. The light steering areas 112a-112f may receive equal light, or may each receive varying amounts of light from the LEDs 102a, 102b, 102c. As shown, the LEDs 102a, 102b, 102c are arranged in a linear configuration and spaced along a side 109 of the collection optic 108 and proximately aligned with the collection optic 108. In this manner, the collection optic 108 is capable of directing light received from LEDs 102a, 102b, and 102c toward light steering areas 112a-112f. It should be appreciated that other numbers of LEDs may be used and variously positioned such that more than one collection optic 108 may be used.

The reflector optic 110 is in optical communication with the collection optic 108 and is configured to reflect light received therefrom. The reflector optic 110 may include a total internal reflection (TIR) optic or a coated reflector optic. In addition, the reflector optic 110 may be configured to extend the same length as the collection optic 108 to increase the amount of light reflected towards the light steering areas 112a-112f. The light steering areas 112a-112f extend inwardly into the first optical element 104 from the reflector optic 110.

As previously noted, the light steering areas 112a-112f are in optical communication with the reflector optic 110 and are configured to steer light propagating in the first optical element 104. Each light steering area 112a-112f may include a TIR optic, coated reflector optic, or a form of a TIR optic, such as a wedge prism. Each light steering area 112a-112f may be variously located and may be parallel or non-parallel with any other light steering area 112a-112f. In addition, each light steering area 112a-112f may be regularly shaped or irregularly shaped, and each of the light steering areas 112a-112f may include different sizes. As shown, light steering areas 112a-112f may each be located at different distances from the reflector optic 110 and may be staggered with respect to one another. In the illustrated embodiment, light steering areas 112a-112f are disposed on an arcuate lower wall. The light steering areas 112a-112f may increase or decrease in size, depending on the application, or may be uniform in size. In addition, the space between each of the light steering areas 112a-112f may be constant or vary. Regardless, the light steering areas 112a-112f are generally configured to direct light propagating in the first optical element 104 outward toward an output surface 114.

With reference again to FIGS. 1 and 2, light steered from the light steering areas 112a-112f exits the first optical element 104 through the output surface 114. The output surface 114 may be a light spreading optic such as, but not limited to, an array of square pillow-type lenses (e.g. pillow optics) 115 configured to spread light exiting the first optical element 104. In the illustrated embodiment, the collection optic 108 is positioned generally perpendicular to the output surface 114, such that light emitted from the LEDs 102a, 102b, 102c enters the first optical element 104 (via the collection optic 108) from a first direction and exits the first optical element 104 optic (via the output surface 114) in a direction that is 10-60 degrees relative to the normal of the output surface 114.

Light exiting the first optical element 104 is received in the second optical element 106, which is in optical communication with the first optical element 104. A planar extent of the second optical element 106 may be positioned parallel to a planar extent of the output surface 114 of the first optical element 104. It should be appreciated that the second optical element 106 may be configured in a variety of shapes and/or sizes. In the illustrated embodiment, the second optical element 106 has a planar configuration and receives light through a proximal side 116 located closest to the first optical element 104. Light entering the second optical element 106 is diffused and may be used to substantially evenly or substantially unevenly illuminate an indicia 120 located on either the proximal side 116, a distal side 122, or both the proximal side 116 and distal side 122 of the second optical element 106. The indicia 120 may be any indicator or symbol that conveys a message to the driver such as a blind spot detection indicator or a turn signal indicator, for example. It is contemplated that the indicia 120 may be masked or laser ablated from a coating 124 deposited on the distal side 122 of the second optical element 106. Additionally, other sides of the second optical element 106 may also be coated to prevent light from escaping therethrough.

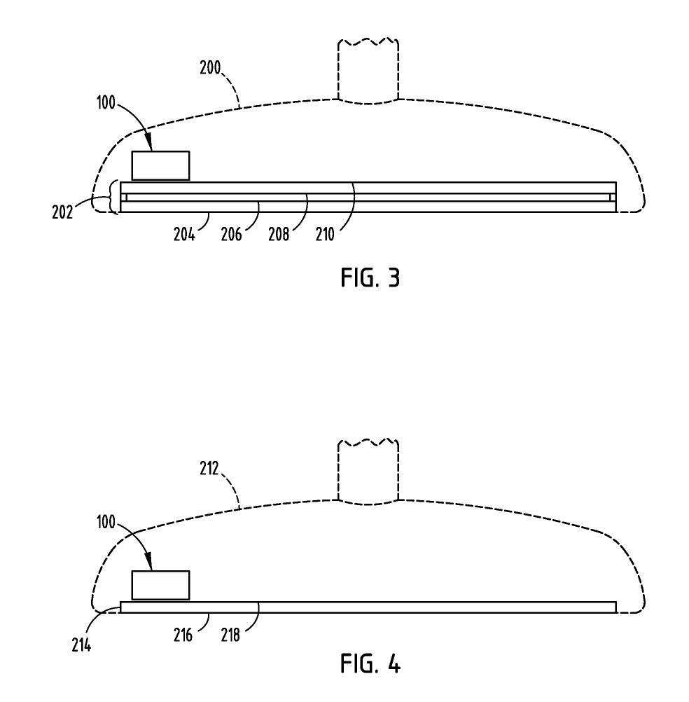

Alternatively, the second optical element 106 may also be provided without the indicia 120 when a rearview mirror assembly already includes desired indicia. The rearview mirror assembly may be an inside rearview assembly or an outside rearview assembly. For instance, as shown in FIG. 3, the light system 100 may be used in a rearview mirror assembly 200 having an electro-optic mirror element 202 (e.g. an electrochromic mirror) with multiple surfaces, shown as a first surface 204, a second surface 206, a third surface 208, and a fourth surface 210. In such an arrangement, indicia (not shown) may be located on either one of the first, second, third, and fourth surfaces 204-210. Accordingly, the light system 100 may be positioned proximate the interior-most surface (fourth surface 210) of the rearview mirror assembly 200 and properly aligned such that light exiting from the second optical element 106 or the first optical element 104 (if the second optical element 106 is not used) may illuminate the indicia. In another instance, as shown in FIG. 4, the light system 100 may be used in a rearview mirror assembly 212 having a non electro-optic mirror element 214 (e.g. a glass mirror element) with a first surface 216 and a second surface 218. In such an arrangement, indicia (not shown) may be located on either one of the first and second surfaces 216, 218. Accordingly, the light system 100 may be positioned proximate the interior-most surface (second surface 218) of the rearview mirror assembly 212 and properly aligned such that light exiting from the second optical element 106 or the first optical element 104 (if the second optical element 106 is not used) may illuminate the indicia. For rearview mirror assemblies lacking indicia 120, a light system having a second optical element 106 with an indicia may be similarly incorporated therein.

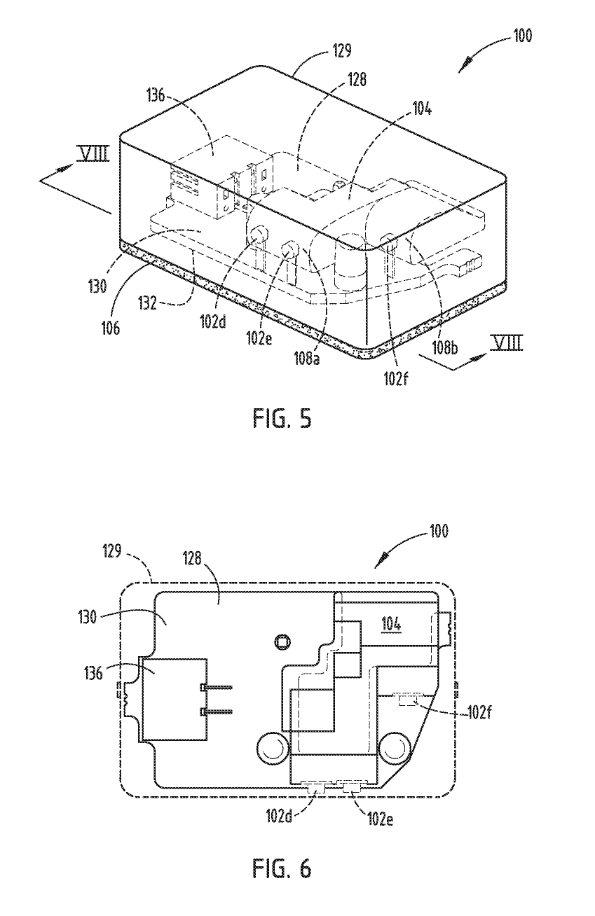

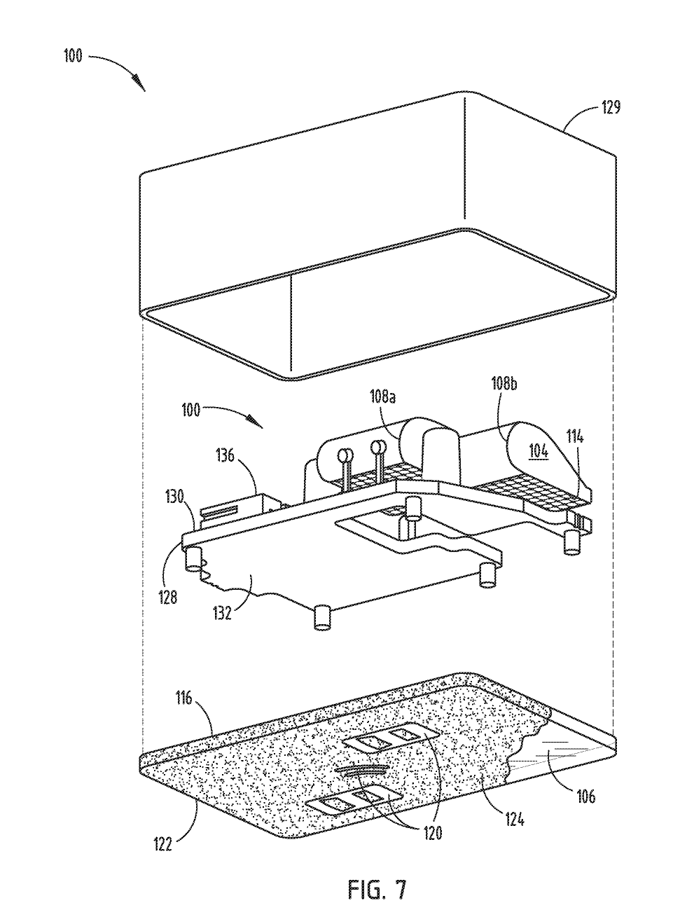

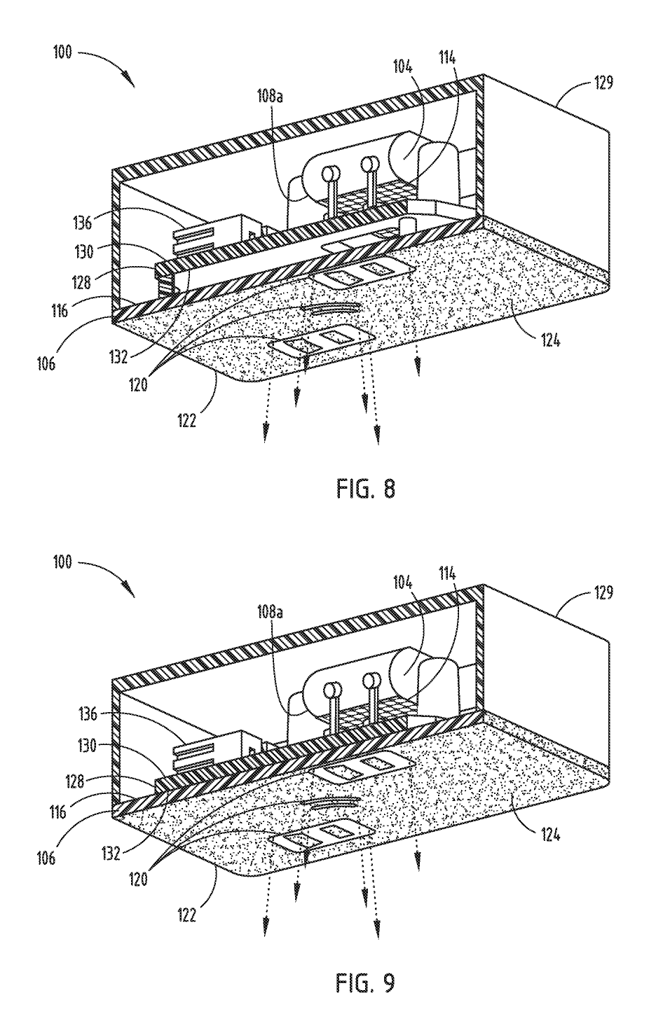

Referring to FIGS. 5-8, the light system 100 is shown according to another embodiment. In the illustrated embodiment, the light system 100 includes a printed circuit board (PCB) 128 secured inside a cover 129 (e.g. via mechanical fasteners, friction, or other suitable means) and having a first side 130 and a second side 132. The light source, shown as LEDs 102d, 102e, and 102f, are located on the first side 130 of the PCB 128 and are exemplarily shown in a non-linear configuration. The first optical element 104 is coupled to the first side 130 of the PCB 128 and is located in an elevated position relative to LEDs 102d, 102e, and 102f. The LEDs 102d and 102e are proximately aligned with collection optic 108a and LED 102f is proximately aligned with collection optic 108b resulting in a staggered configuration of the collection optic 108a and the collection optic 108b. The first optical element 104 may be coupled to the first side 130 of the PCB 128 using standoffs or the like. As shown, the PCB 128 has a gap, through which light exiting the first optical element 104 (via the output surface 114) propagates towards and is received in the second optical element 106, which is located on the second side 132 of the PCB 128. While the gap is shown having a similar profile to the output surface 114 of the first optical element 104, it should be appreciated that the gap is not necessarily limited to any particular shape and/or size.

In the illustrated embodiment, the second optical element 106 may be coupled to the second side 132 of the PCB 128 using standoffs or the like. Alternatively, the second optical element 106 may directly contact the PCB 128, thereby reducing the height of the light system 100 (see FIG. 9). In any event, the second optical element 106 and the cover 129 may cooperate to define a sealed housing that encloses the PCB 128, the LEDs 102d, 102e, 102f, and the first optical element 104, which may be accomplished via laser welding or other suitable means. Alternatively, the second optical element 106 may be excluded from the light system 100, such that the cover 129 may be configured to cooperate with the PCB 128 to define the housing. Such an arrangement may be advantageous when a rearview mirror assembly already has desired indicia. As previously mentioned, some rearview mirror assemblies may already have indicia located on at least one surface of an electro-optic mirror element 202 (e.g. electrochromic element) or a non electro-optic mirror element 214, thus obviating the need to either provide a like indicia on the second optical element 106 or include the second optical element 106 altogether in the light system 100. In such circumstances, light exiting the second optical element 106, or the first optical element 104 (in the absence of the second optical element 106) may be used to illuminate indicia of the rearview mirror assembly.

Regardless of the configuration, the light system 100 advantageously provides for a low profile (e.g., thin) packaged design and may be integrated with other electrical devices via electrical connector 136, which may be configured to receive electrical power and/or make electrical connections. By positioning the light sources on a side of the first optical element 104, a very low profile assembly design may be constructed. The arcuate surface of the reflector optic 110 and the wedges increase the overall extent in which light may be captured, controlled, or otherwise channeled and directed toward the output surface 114, thereby increasing one or more of useable area, luminance, and uniformity of the light system 100.

Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications may be made on the aforementioned structures and methods without departing from the concepts of the present invention, and further it is to be understood that such concepts are intended to be covered by the following claims unless these claims by their language expressly state otherwise.

What is claimed is:

1. A light system for use in a rearview mirror assembly, comprising:
a printed circuit board having a first side and a second side;
a light source located on the first side and configured to direct light in a first direction parallel with a planar extent of the printed circuit board;
a first optical element coupled to the first side and having:
a collection optic configured to direct light received from the light source; and
a plurality of light steering areas configured to steer light propagating in the first optical element, wherein light steered from each of the plurality of light steering areas exits the first optical element via an output surface configured to direct light in a second direction that is generally 10-60 degrees relative to a planar extent of the output surface; and
a second optical element coupled to the second side and in optical communication with the first optical element, wherein the second optical element is configured to diffuse light received from the first optical element to illuminate an indicia.

2. The light system of claim 1, wherein the collection optic is elongate and convex.

3. The light system of claim 1, wherein the light source comprises a plurality of light emitting diodes spaced along a length of the collection optic and proximately aligned with the collection optic.

4. The light system of claim 1, wherein each of the plurality of light steering areas is located at a different distance from a reflector optic than the others of the plurality of light steering areas.

5. The light system of claim 1, wherein the indicia is one of a blind spot detection indicator and turn signal indicator.

6. The light system of claim 1, wherein the indicia is disposed on an electro-optic element.

7. The light system of claim 1, further comprising a cover configured to cooperate with the second optical element to define a housing that encloses the printed circuit board, the light source, and the first optical element.

8. The light system of claim 1, wherein the plurality of light steering areas includes first and second light steering areas, wherein the first light steering area is closer to the light source than the second light steering area, and wherein the first light steering area is smaller than the second light steering area.

9. A light system for use in a rearview mirror assembly, comprising:
a printed circuit board;
a light source proximate the printed circuit board directing light in a first direction;
a first optical element operably coupled to the printed circuit board and having:
a collection optic that directs light received from the light source;
an output surface including a light spreading optic; and
a plurality of light steering areas that steer light propagating in the first optical element, wherein light steered from each of the plurality of light steering areas exits the first optical element via the output surface configured to direct light in a second direction different from the first direction; and
a second optical element in optical communication with the first optical element, wherein the second optical element is configured to diffuse light received from the first optical element to illuminate an indicia having a planar extent that is generally perpendicular to the light emitted by the light source.

10. The light system of claim 9, wherein the collection optic includes a staggered configuration.

11. The light system of claim 9, wherein the light source comprises a plurality of light emitting diodes spaced along a length of the collection optic and proximately aligned with the collection optic.

12. The light system of claim 9, wherein each of the plurality of light steering areas is located at a different distance from a reflector optic than the others of the plurality of light steering areas.

13. The light system of claim 9, wherein the indicia is one of a blind spot detection indicator and turn signal indicator.

14. The light system of claim 9, wherein the indicia is disposed on an electro-optic element.

15. The light system of claim 9, further comprising a cover configured to cooperate with the second optical element to define a housing that encloses the printed circuit board, the light source, and the first optical element.

16. The light system of claim 9, wherein a gap is defined between the printed circuit board and the second optical element.

17. A light system for use in a rearview mirror assembly, comprising:
a printed circuit board;
a light source proximate the printed circuit board directing light in a first direction;
a first optical element operably coupled to the printed circuit board and having:
a collection optic that directs light received from the light source;
an output surface including a light spreading optic; and
a plurality of light steering areas that steer light propagating in the first optical element, wherein light steered from each of the plurality of light steering areas exits the first optical element via the output surface and wherein the plurality of light steering areas increase in size as a distance from the light source increases; and
a second optical element in optical communication with the first optical element, wherein the second optical element includes indicia that is illuminated by the light source.

18. The light system of claim 17, wherein the light source comprises a plurality of light emitting diodes spaced along a length of the collection optic and proximately aligned with the collection optic.

19. The light system of claim 17, wherein the indicia is disposed on an electro-optic element.

20. The light system of claim 17, wherein at least one of the plurality of light steering areas includes at least one of a total internal reflection optic and a coated reflector optic.
